(19) United States
(12) Patent Application Publication
(10) Pub. No.: US 2004/0234365 A1
(43) Pub. Date: Nov. 25, 2004

(54) Vehicle tire installation aid

(76) Inventor: Michael Lowell Stevens, San Diego, CA (US)

Correspondence Address: Michael L. Stevens, 20450 Huntcliff Ln., Walnut, CA, 91789, US

(21) Appl. No.: 10/440,911

(22) Filed: May 20, 2003

(51) Int. Cl. B65G 7/00

(52) U.S. Cl. 414/426

(57) ABSTRACT

A device for use in the installation of a tire wheel assembly onto the axle of a jacked vehicle. The device consists of two end supports connected by two parallel bars each of which contains a roller-slider assembly. The device also contains a telescoping alignment wand mounted between the parallel rods. After the alignment wand is used to position the device, the tire is placed on the roller-sliders and pushed toward the axle hub. The tire is rotated to align the wheel with the axle's lug bolts and the wheel is pushed onto the lug bolts. The tire wheel assembly may then be fastened to the axle.

### CROSS REFERENCE TO RELATED APPLICATION

Not Applicable

### STATEMENT REGARDING FEDERALLY SPONSERED RESEARCH

Not Applicable

### REFERENCE TO SEQUENCE LISTING, TABLE, OR A COMPUTER PROGRAM LISTING APPENDIX

Not Applicable

1. Background of the Invention

This invention relates to the field of devices used to assist in the supporting and aligning of tire wheel assemblies during their installation onto the axle of a jacked vehicle.

2. Description of the Prior Art

Most passenger vehicles and light trucks carry a spare tire on the vehicle in case one of the installed tires is punctured. To replace the tire, the operator raises the flat tire off the ground using the vehicle's jack. The lug nuts are removed from the lug bolts and the flat tire's wheel assembly is removed from the axle hub. The spare tire's wheel assembly must then be lifted up and rotated to align the wheels lug bolt holes with the lug bolts on the axle hub. Due to the weight and bulk of the tire wheel assembly, lifting and rotating the unit without assistance can be difficult if not impossible for many. A number of devices exist in the prior art for assisting the lifting and manipulation of the spare tire during installation.

U.S. Pat. No. 2,569,242 issued to Kors relates to a fulcrum type device where the tire sits on one end of a bar and the operator pushes down the other end to raise the tire.

U.S. Pat. No. 2,639,121 issued to Hudspeth relates to a fulcrum type device where the tire sits between the forks on one end and the operator pushes down on the other end.

U.S. Pat. No. 346,337 issued to Reznicek relates to a handcart type device with wheels. The operator rolls the device into location, ratchets the tire up and then rotates it on rollers into position.

U.S. Pat. No. 3,348,294 issued to Gerardi relates to a bar passing through the center of the wheel and resting atop the axle hub. The bar is lifted to raise the tire and the tire slides down the bar onto the axle.

U.S. Pat. No. 4,602,415 issued to Garcia relates to a device with two rods passing through the wheels lug holes and attaching to the lug bolts.A long handle is used to lift the tire.

U.S. Pat. No. 4,256,430 issued to Pugel relates to a device with a seat and rollers. The operator wheels the device into position, then sits on the seat to raise the tire

### SUMMARY OF THE INVENTION

It is the object of the invention to provide a device for assisting in the installation of a tire wheel assembly to the axle of a jacked vehicle. The device contains a telescoping alignment wand for use in locating the device directly beneath the axle hub. The alignment wand is also used for aligning the center of the axle hub with the center of the tire wheel assembly. The device contains two parallel bars connected together by end supports. On each parallel bar a roller-slider is located. The roller-sliders rotate around the axis of and slide the length of the parallel bars. A tire wheel assembly being placed upon the roller-sliders of the aligned device, is rotated until the wheel's lug holes line up with the axle's lug bolts. The wheel is then slid onto the lug bolts and fastened to the axle.

### BRIEF DESCRIPTION OF THE DRAWINGS

FIG. 1 is a perspective view of the device.

FIG. 2 is a perspective view of the device with the telescoping alignment wand extended.

FIG. 3 is a side view of the device with the tire and axle hub in alignment.

FIG. 4 is a side view of device depicting the manipulation of the tire towards the axle.

### DETAILED DESCRIPTION OF THE INVENTION

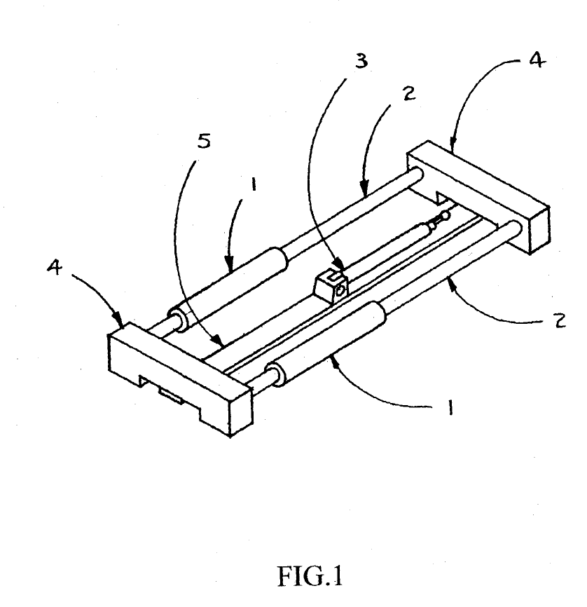

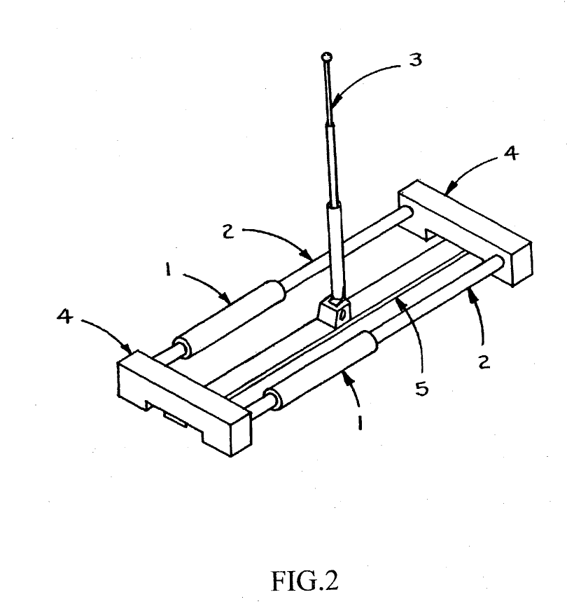

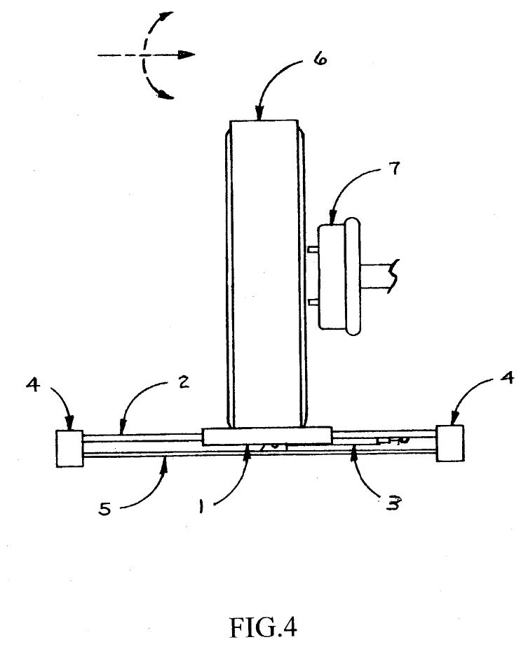

The wheel installation device as shown in perspective, FIG. 1. Is composed of two parallel bars (2) attached at their ends by end supports (4). The parallel bars may be constructed of either solid round bar or round tube, and affixed in a variety of manners to the end supports. The end supports act as the feet of the device and when placed on a flat surface hold the parallel bars on the same plane. A roller-slider (1) is mounted on each parallel bar between the end supports. The roller-slider, essentially a sleeve whose inside diameter is greater than the outside diameter of the parallel bar, is free to rotate around and slide the length of the parallel bar. The roller-slider may be made of metal, plastic, or any other material provided it is of sufficient hardness and low friction. Located between the parallel bars and attached to the end supports is the alignment wand support (5). The alignment wand support, a flat bar, has mounted at its midpoint the telescoping alignment wand (3). The telescoping alignment wand is essentially of a type and construction similar to that used in the art of radio and television antenna. Taken as a unit, the alignment wand support is attached to the end supports at a location so as to position the telescoping alignment wand equidistant from and parallel to the parallel bars when folded flat against the wand support. As shown in the drawings, the telescoping alignment wand rotates 90 degrees from a position parallel to the parallel bars FIG. 1 to a position perpendicular to the parallel bars FIG. 2. In addition, as observed in FIG. 4, the alignment wand is located below the top of the roller-sliders to provide clearance for the tire wheel assembly (6).

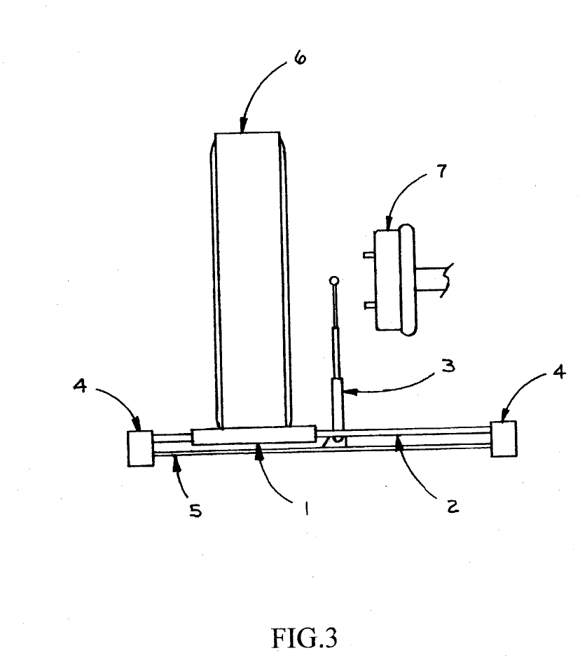

To use the device on a jacked vehicle, using FIG. 3 as reference, the operator places the tire wheel assembly (6) atop the roller-sliders. The telescoping alignment wand is extended to the centerpoint of the wheel. The tire is then removed from the device. The operator then places the device beneath the vehicle axle hub (7) with the alignment wand in close proximity to the axle hub. The device is manually positioned on the axle hubs horizontal axis by centering the alignment wand with the axle hub. The device is centered on the axle hubs vertical axis by raising or lowering the axle using the vehicles jack. With the device now properly located, the tire is again placed atop the roller-sliders and is now in alignment with the axle hub.

Now referring to FIG. 4, the operator returns the alignment wand to the position parallel to the parallel bars. The tire wheel assembly is then manipulated onto the axle hub by sliding the tire towards the axle hub and rotating the tire to align the wheel's lug holes with the axle's lug bolts as shown by the direction of the arrows. Once the lug bolts have penetrated the lug holes the tire wheel assembly can then be fastened to the axle hub.

What is claimed is:

1. A vehicle wheel installation device for mounting a tire wheel assembly to the axle of a vehicle comprised of:
Two parallel bars
Two roller-slider assemblies
Two end supports connecting the parallel bars
One alignment wand support
One telescoping alignment wand

2. A vehicle wheel installation device in claim 1 wherein said roller-sliders rotate around the axis of said parallel bars.

3. A vehicle wheel installation device in claim 2 wherein said roller-sliders slide longitudinally along said parallel bars.

4. A vehicle wheel installation device in claim 1 wherein said telescoping alignment wand extends perpendicular to said parallel bars when used to align the device to the vehicle axle hub.

5. A vehicle wheel installation device in claim 4 wherein said telescoping alignment wand folds to a position parallel to said parallel bars.
